(19) United States
(12) Patent Application Publication
(10) Pub. No.: US 2019/0050811 A1
(43) Pub. Date: Feb. 14, 2019

(54) PROJECT SCHEDULING SYSTEM AND METHOD

(71) Applicants: Brian Kang, Cromwell, CT (US); Keith Tanner, Colchester, CT (US)

(72) Inventors: Brian Kang, Cromwell, CT (US); Keith Tanner, Colchester, CT (US)

(21) Appl. No.: 15/675,984

(22) Filed: Aug. 14, 2017

(51) Int. Cl. G06Q 10/10; G06Q 10/06

(52) U.S. Cl. CPC G06Q 10/103; G06Q 10/1097; G06Q 10/101; G06Q 10/06314; G06Q 10/06313; G06Q 10/063116

(57) ABSTRACT

Disclosed embodiments provide systems and methods for project scheduling. A project can include multiple tasks, and each task can include multiple subtasks. Each subtask can then in turn include multiple discrete actions. Each task, subtask, and discrete action has various properties associated with it, such as an owner and estimated completion date. Disclosed embodiments provide a temporally condensed view of outstanding discrete actions based on a filter date. This allows a project manager to view the outstanding discrete actions for a project. The filter date allows a specific time to be entered for which to perform this analysis. The condensed view of outstanding discrete actions based on a filter date thus allows a project manager the ability to quickly and accurately assess outstanding tasks, something which is a key aspect of successful project management.

### FIELD OF THE INVENTION

The present invention relates generally to computer systems, and more particularly to a project scheduling system and method.

### BACKGROUND

Project management systems include software used for project planning, scheduling, resource allocation and change management. They allow project managers (PMs), stakeholders and users to control costs and manage budgeting, quality management and documentation and also may be used to perform some administrative functions.

A project management system is a tool that helps teams and companies collaborate and meet goals on time while managing both resources and costs. Managing projects has grown increasingly complex in recent years. Due to this complexity, large projects, such as construction projects, software development projects, consumer electronics development projects, and industrial design projects can often finish beyond their estimated completion dates, over-budget, and with a lower than predicted return on investment. Management professionals often rely on project management systems to help them oversee multiple concurrent projects. Therefore, it is desirable to have improvements in project management systems.

### SUMMARY

In one aspect, there is provided a computer-implemented method for task scheduling of one or more tasks, subtasks, and discrete actions, comprising: obtaining a plurality of task records from a database; obtaining a plurality of subtask records from the database; obtaining a plurality of discrete action records from the database; retrieving a completion status for each task record, subtask record, and discrete action record; retrieving a completion due date for each task record, subtask record, and discrete action record; obtaining a filter date; and rendering, on an electronic display, a temporally condensed view of outstanding discrete actions based on the filter date.

In another aspect, there is provided an electronic device for task scheduling of one or more tasks, subtasks, and discrete actions, comprising: a processor; a memory coupled to the processor; a display coupled to the processor; wherein the memory contains instructions, which when executed by the processor, perform the steps of: obtaining a plurality of task records from a database; obtaining a plurality of subtask records from the database; obtaining a plurality of discrete action records from the database; retrieving a completion status for each task, subtask, and discrete action; retrieving a completion due date for each task, subtask, and discrete action; obtaining a filter date; and rendering, on the electronic display, a temporally condensed view of outstanding discrete actions based on the filter date.

In yet another aspect, there is provided a computer program product embodied in a non-transitory computer readable medium for task scheduling of one or more tasks, subtasks, and discrete actions, the computer program product comprising instructions which cause one or more processors to perform operations of: obtaining a plurality of task records from a database; obtaining a plurality of subtask records from the database; obtaining a plurality of discrete action records from the database; retrieving a completion status for each task, subtask, and discrete action; retrieving a completion due date for each task, subtask, and discrete action; obtaining a filter date; and rendering, on an electronic display, a temporally condensed view of outstanding discrete actions based on the filter date.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity. Furthermore, for clarity, some reference numbers may be omitted in certain drawings.

FIG. 1 shows an exemplary project calendar layout.

FIG. 2 shows an exemplary temporally condensed view of the project calendar layout of FIG. 1 in accordance with embodiments of the present invention.

FIG. 3 shows an exemplary temporally condensed view showing additional information in accordance with embodiments of the present invention.

FIG. 4 shows an exemplary temporally condensed view based on a future filter date in accordance with embodiments of the present invention.

FIG. 5 shows an exemplary temporally condensed view based on a past filter date in accordance with embodiments of the present invention.

FIG. 6 shows an exemplary system in accordance with embodiments of the present invention.

FIG. 7 shows a device in accordance with embodiments of the present invention.

FIG. 8 is a flowchart indicating process steps for embodiments of the present invention.

FIG. 9 is a flowchart showing data entry steps.

FIG. 10 is a flowchart showing discrete action management steps.

FIG. 11 illustrates an exemplary three-dimensional temporally condensed rendering of outstanding discrete actions in accordance with embodiments of the present invention.

### DETAILED DESCRIPTION

Disclosed embodiments provide systems and methods for project scheduling. A project can include multiple tasks, and each task can include multiple subtasks. Each subtask can then in turn include multiple discrete actions. Each task, subtask, and discrete action has various properties associated with it, such as an owner and estimated completion date.

The daily management of a long and complex project can be challenging. With a project that extends over many weeks or months, it can be challenging to assess the outstanding tasks. This assessment is critical for a project manager to drive daily tasks, and make adjustments that are typically required on long and complex projects.

Disclosed embodiments provide a temporally condensed view of outstanding discrete actions based on a filter date. This allows a project manager to view the outstanding discrete actions for a project. The filter date allows a specific time to be entered for which to perform this analysis. In many cases, the project manager uses the present date as the filter date to determine the currently outstanding tasks. By getting a clear mental picture of the outstanding tasks, the project manager can successfully orchestrate activities, and perform adjustments as needed to keep the project moving forward. The project manager may also use a filter date in the future to get an assessment of workload in future weeks and months. Additionally, the project manager may use a filter date in the past for functions such as assessing worker performance, and/or assessing progress to date. The condensed view of outstanding discrete actions based on a filter date thus allows a project manager the ability to quickly and accurately assess outstanding tasks, something which is a key aspect of successful project management.

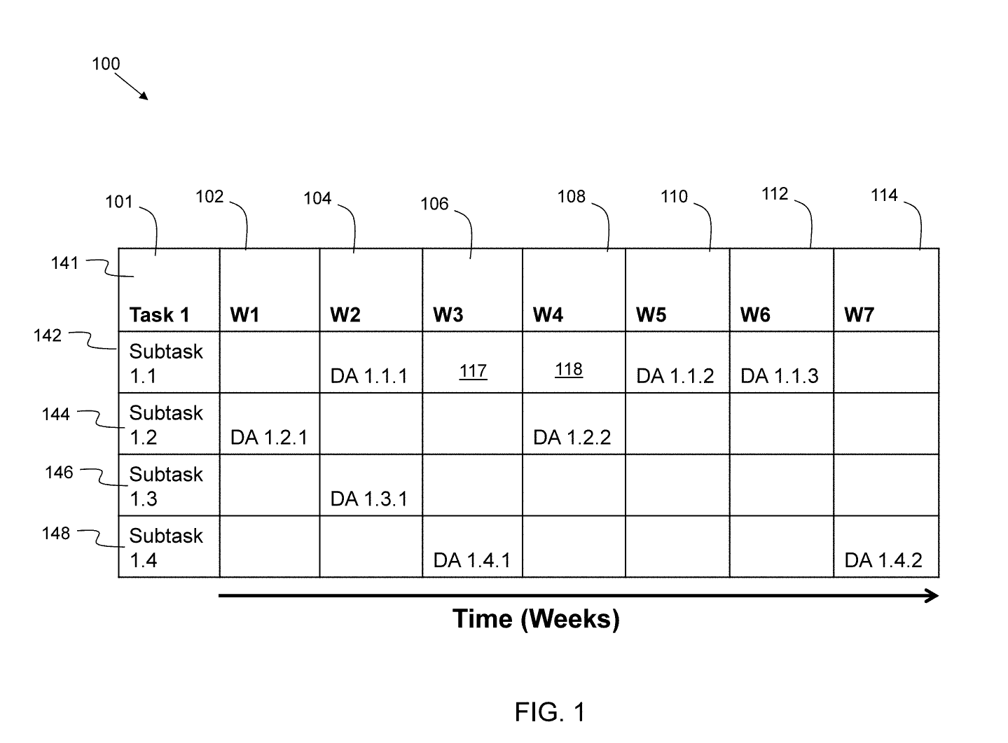

FIG. 1 shows an exemplary project calendar layout 100. The calendar layout 100 includes multiple columns, indicated as 101, 102, 104, 106, 108, 110, 112, and 114. Similarly, the calendar layout 100 includes multiple rows, indicated as 141, 142, 144, 146, and 148. Column 101 shows various project items including a task (indicated at row 141 and column 101), and multiple subtasks (indicated at column 101 in rows 142, 144, 146, and 148).

Row 141, starting at column 102, shows various weeks of a project. For example, at row 141 column 102 is week W1, at row 141 column 104 is week W2, etc. While seven weeks (W1-W7) are shown in this example, in practice, a long and complex project can continue for many months or years. Thus, in practice there can be many more weeks than what is illustrated in FIG. 1. A project is comprised of one or more tasks. For each task, there are one or more subtasks defined. For each subtask, there is one or more discrete actions (DA) defined. Thus, there is a hierarchy of project, task, subtask, and discrete action. In some embodiments, the default calendar layout is in days, and being able to show weeks, months, quarters, and/or years as desired. Other, user-defined time units are possible. For example, if a user prefers a two-week unit of time (e.g. for an Agile sprint in software development), the user can establish a customized time unit of two weeks to match their business/development practices.

As an example, a project can include construction of a building. A first task can include preparing the land. A subtask of the first task can include applying for permits. One discrete action of the permit subtask can include applying for state permits, another discrete action of the permit subtask can include applying for local permits.

Referring again to FIG. 1, multiple discrete actions are shown for various subtasks. Referring to row 142, there are three discrete actions for subtask 1.1. Discrete action 1.1.1 is shown at row 142 column 104, discrete action 1.1.2 is shown at row 142 column 110, and discrete action 1.1.3 is shown at row 142 column 112. As can be seen for subtask 1.1, week W3 (indicated by reference 117) and week W4 (indicated by reference 118) do not have any discrete actions scheduled for subtask 1.1. Similarly, referring to row 148 for subtask 1.4, weeks W4, W5, and W6 also do not have any discrete actions for subtask 1.4. In practice, there are many situations where tasks, subtasks, and/or discrete actions are dependent on completion of other discrete actions, thus creating temporal gaps such as those indicated by references 117 and 118. This can create challenges for a project manager to mentally grasp the outstanding tasks.

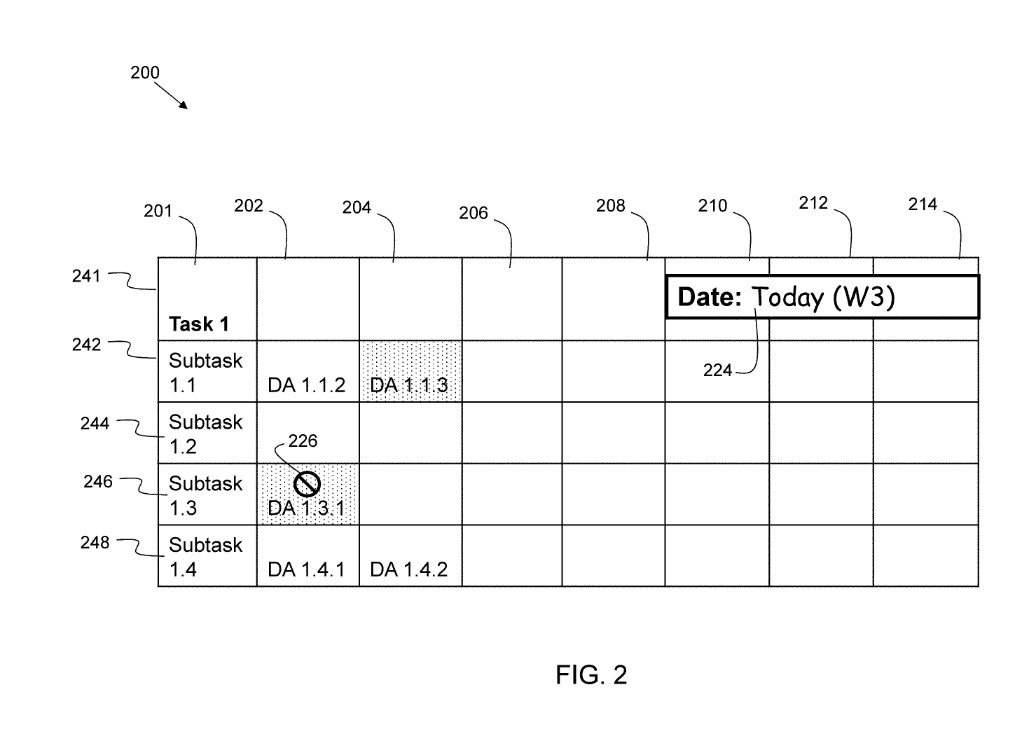

FIG. 2 shows an exemplary temporally condensed view 200 of the project calendar layout of FIG. 1 in accordance with embodiments of the present invention. The temporally condensed view 200 includes multiple columns, indicated as 201, 202, 204, 206, 208, 210, 212, and 214. Similarly, the temporally condensed view 200 includes multiple rows, indicated as 241, 242, 244, 246, and 248. A filter date field 224 allows a user to enter a date for the starting point of the temporally compressed view. In the example, the user has selected the present date, which refers to week W3. Thus, for the purposes of the examples described herein, the current week is week W3. Since, the user selected week W3, the discrete actions shown are discrete actions that are not complete as of W3. Thus, referring again to FIG. 1, discrete action DA 1.1.1 for row 142 column 104 is not rendered in temporally condensed view 200, since that discrete action was completed in week W2. Furthermore, the gaps shown in project calendar layout 100 are removed in the temporally condensed view 200. For example, in temporally condensed view 200, discrete action DA 1.1.2 in row 242 column 202 is rendered directly adjacent to discrete action DA 1.1.3 in row 242 column 204. The gaps (shown as 117 and 118 in FIG. 1) are removed, thus creating the temporally condensed view. Similarly, for subtask 1.4 in row 248, discrete action DA 1.4.1 is rendered adjacent to discrete action DA 1.4.2. In this way, a user, such as a project manager can quickly see outstanding tasks. Each task, subtask, and discrete action may be assigned a unique number that is used for identification and tracking of that item. Additionally, visual coding, such as color coding, and/or pattern fill may be used to symbolically represent an item owner. For example, discrete action DA 1.1.3 at row 242 column 204 has a pattern fill to indicate a different owner than discrete action DA 1.1.2 at row 242 column 202. Thus, embodiments include assigning a color to each discrete action based on a discrete action owner.

Symbols may also be used to allow a user such as a project manager to quickly assess issues such as late discrete actions. Additionally, symbols may also be used to identify the responsible owner of a discrete action. Furthermore, the symbols can serve as another method of identifying the owner that does not rely on color coding, making the information easily accessible to those who are color blind. As an example of symbol usage, discrete action DA 1.3.1 at row 246 column 202 is indicated as being late by late discrete action indication 226. Referring again to FIG. 1, discrete action 1.3.1 was scheduled for completion in week W2 (column 146 row 104). However, as that discrete action is not complete, it is shown in the temporally compressed view 200 with a filter date of week W3, and including late discrete action indication 226. Thus, embodiments can include rendering a late discrete action indication.

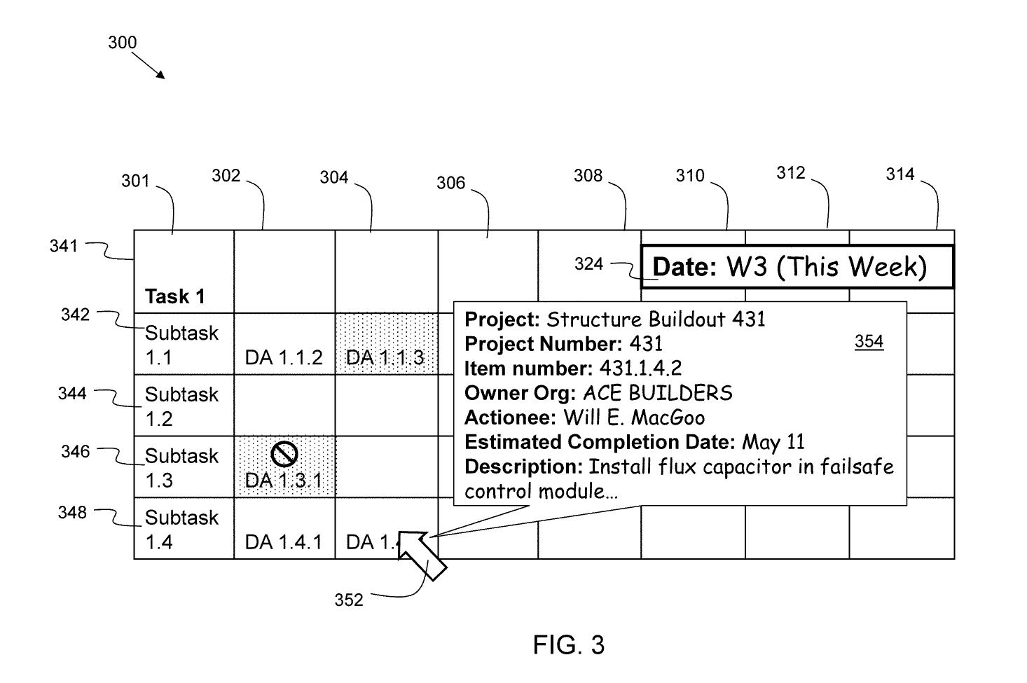

FIG. 3 shows an exemplary temporally condensed view 300 showing additional information in accordance with embodiments of the present invention. Similar, to the temporally condensed view 200 of FIG. 2, the temporally condensed view 300 includes multiple columns, indicated as 301, 302, 304, 306, 308, 310, 312, and 314. Similarly, the temporally condensed view 300 includes multiple rows, indicated as 341, 342, 344, 346, and 348. The filter date field 324 is also set to refer to week W3. In this example, the user has moved the mouse cursor 352 over a particular discrete action to obtain additional information. In embodiments, this operates similar to a tool tip. When the user mouses over the cell for discrete action DA 1.4.2 at row 348 column 304, additional information 354 is displayed. The information may include a project name, a project number, an item number, an owner organization, an actionee, an estimated completion date, and/or a description. Other fields are possible. In some embodiments, the item number may be a unique number to each discrete action based on a discrete action owner. In some embodiments, the item number may be a unique number to each discrete action based on a unique project number. In the example, the project number (431) is prepended to the discrete action number to form the item number. In some embodiments, the discrete action number is of the form:

### T.S.D

Where T is a task number, S is a subtask number, and D is a discrete action number.
Similarly, in embodiments, the item number is of the form:

### Pn.T.S.D

Where Pn is a project number, T is a task number, S is a subtask number, and D is a discrete action number. In embodiments, each project is assigned a unique number, thus ensuring that each item number is unique. Thus, embodiments include assigning a unique number to each discrete action based on a unique project number.

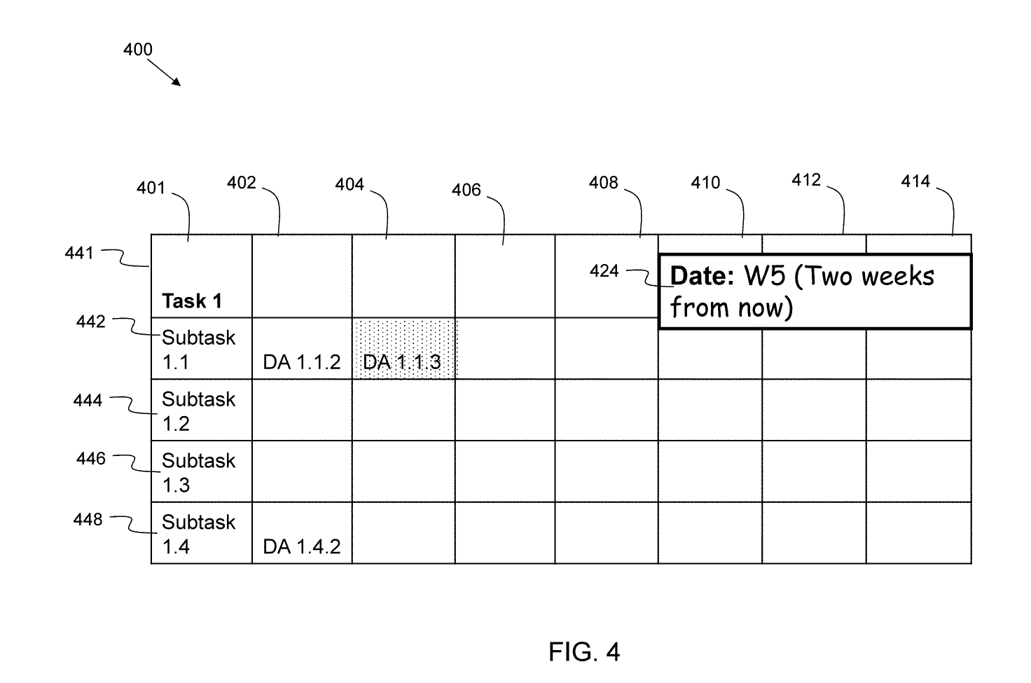

FIG. 4 shows an exemplary temporally condensed view 400 based on a future filter date in accordance with embodiments of the present invention. The temporally condensed view 400 includes multiple columns, indicated as 401, 402, 404, 406, 408, 410, 412, and 414. Similarly, the temporally condensed view 400 includes multiple rows, indicated as 441, 442, 444, 446, and 448. A filter date field 424 allows a user to enter a date for the starting point of the temporally compressed view. In the example, the user has selected a future date, which refers to week W5. In view 400, discrete actions that are expected to be uncompleted at the time of week W5 are shown in a temporally condensed format. Referring again to FIG. 1, there is discrete action DA 1.4.1 in row 148 column 106. This discrete action is not shown in view 400 since that discrete action is expected to be completed prior to the future time specified in the filter date field 424.

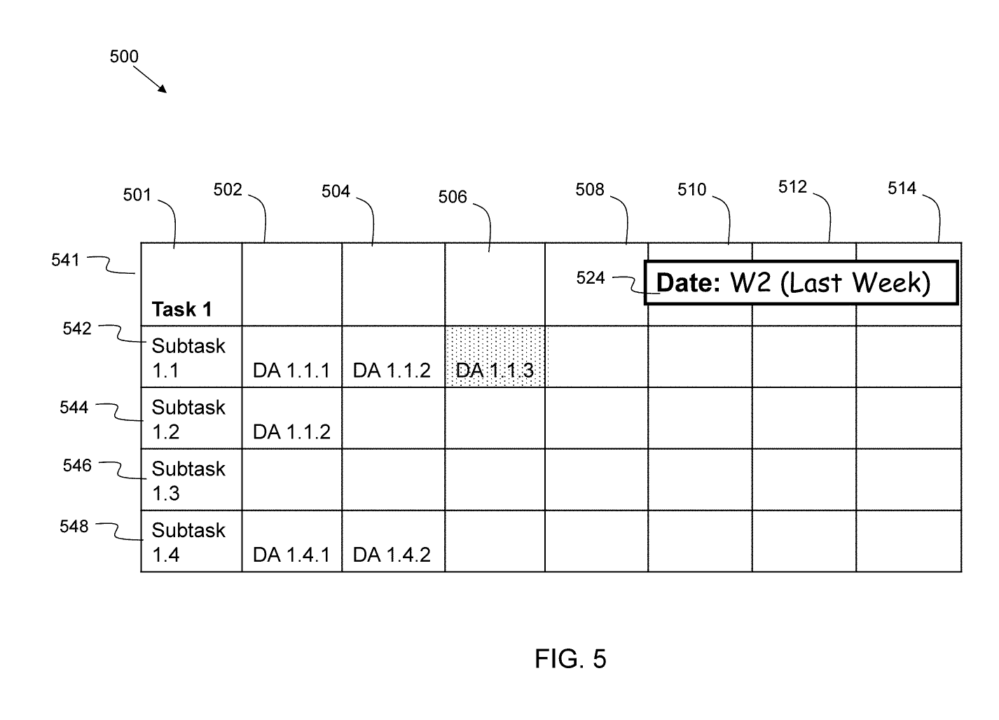

FIG. 5 shows an exemplary temporally condensed view 500 based on a past filter date in accordance with embodiments of the present invention. The temporally condensed view 500 includes multiple columns, indicated as 501, 502, 504, 506, 508, 510, 512, and 514. Similarly, the temporally condensed view 400 includes multiple rows, indicated as 541, 542, 544, 546, and 548. A filter date field 524 allows a user to enter a date for the starting point of the temporally compressed view. In the example, the user has selected a past date, which refers to week W2. The view 500 now shows discrete actions that were not completed as of week W2.

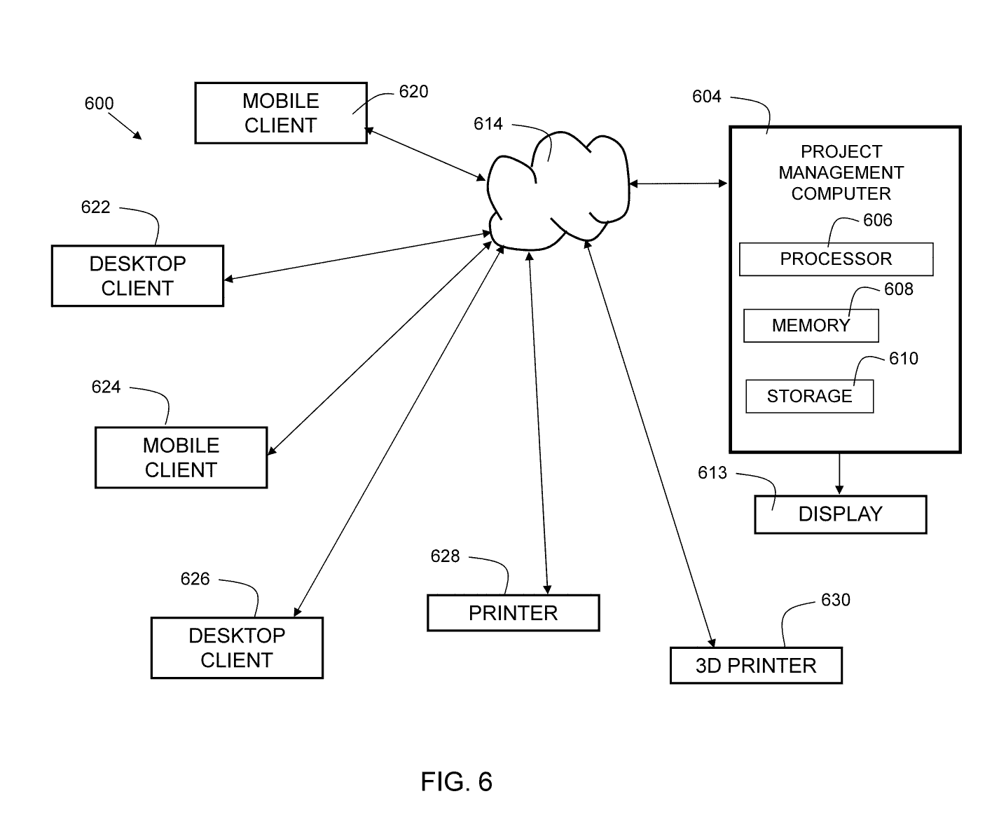

FIG. 6 shows an exemplary system 600 in accordance with embodiments of the present invention. The system 600 can include a project management computer 604. The computer 604 includes a processor 606, memory 608, and storage 610. Project management computer 604 may be configured to operate as a server.

Memory 608 may include dynamic random access memory (DRAM), static random access memory (SRAM), magnetic storage, and/or a read only memory such as flash, EEPROM, optical storage, or other suitable memory. Memory 608 includes instructions for executing steps in accordance with embodiments of the present invention. In embodiments, memory 608 may include non-transitory memory. In embodiments, storage 610 may include one or more magnetic storage devices such as hard disk drives (HDDs). Storage 610 may include one or more solid state drives (SSDs). Any other storage device may be included instead of, or in addition to, those disclosed herein. Network 614 may be the Internet, a wide area network, a local area network, a cloud computing network, an intra-enterprise network, or any other suitable network or combination thereof.

Computer 604 may be coupled to electronic display 613 for rendering temporally condensed views of a project calendar. The electronic display 613 may include a cathode ray tube (CRT), liquid crystal display (LCD), light emitting diode (LED) display, projector, or other suitable display type. The computer 604 and electronic display 613 may be coupled via a logical link such as a virtual network connection. Alternatively, the computer 604 may be coupled to electronic display 613 via a physical link such as HDMI®, DisplayPort™, or the like.

System 600 may further include one or more desktop clients, indicated as reference 622 and reference 626. Additionally, system 600 may further include one or more mobile clients, indicated as reference 620 and reference 624. The mobile clients may include a tablet computer, a smartphone, or other suitable mobile device. In embodiments, the desktop clients and mobile clients may access the project management computer 604 via network 614 using a variety of networking protocols such as TCP/IP and/or UDP.

In embodiments, the storage 610 of project management computer 604 may store a database for one or more projects. The database contains a plurality of records for projects, tasks, subtasks, discrete actions, users, companies, and/or other associated metadata.

In embodiments, when a user, via a desktop client or mobile client requests a temporally condensed view, a request may be sent from the mobile/desktop client to the project management computer. The request may include a project identifier, a filter date, and other associated information. The processor 606 executes instructions to specify uncompleted discrete actions for the project associated with the project identifier. The project identifier may be a unique alphanumeric code used to reference the project data within the database. In embodiments, the database may be a structured query language (SQL) database. In embodiments, the processor 606 then executes a rendering process that renders the discrete actions for each subtask in an adjacent arrangement, and does not include chronological gaps between the discrete actions, even though chronological gaps may exist in the calendar. As an example, the chronological gaps shown in FIG. 1 (example, 117 and 118) are removed in the temporally condensed view 200 of FIG. 2.

System 600 may further include a printer 628. Printer 628 may include a laser printer, inkjet printer, dot matrix printer, or other suitable type of printer. The printer 628 may be used to render a physical copy of a temporally condensed view on paper. In embodiments, the printer 628 is coupled to the project management computer 604 via network 614.

System 600 may optionally include a 3D printer 630. The 3D printer 630 may be used to render a physical representation of a temporally condensed view. One purpose for such an embodiment is to provide accessibility to visually impaired people. Modern computers have made considerable advances in accessibility with features such as text-to-speech. However, text-to-speech can only merely “describe” what a temporally condensed view would look like. By physically rendering such a view in a tactile format, a visually impaired person can quickly ascertain the discrete actions remaining for the subtasks.

In embodiments, an application is executed on a mobile or desktop client to allow changes such as changing of estimated completion dates, changes of owner, etc. Additionally, the application may allow creation of new projects, tasks, subtasks, and/or discrete actions by sending a request to the project management computer 604. In embodiments, the request may be in the form of an HTTP GET/POST, or other RESTful API. In some embodiments, the project management computer 604 may be hosted in a cloud computing environment. In some embodiments, the project management computer 604 may run in a containerized environment or in a virtual machine. In embodiments, project scheduling software that enables temporally condensed views may be implemented in a Software-as-a-Service (SaaS) environment, with a subscription to allow users access to the project scheduling software. In other embodiments, the project scheduling software may be locally hosted within an organization.

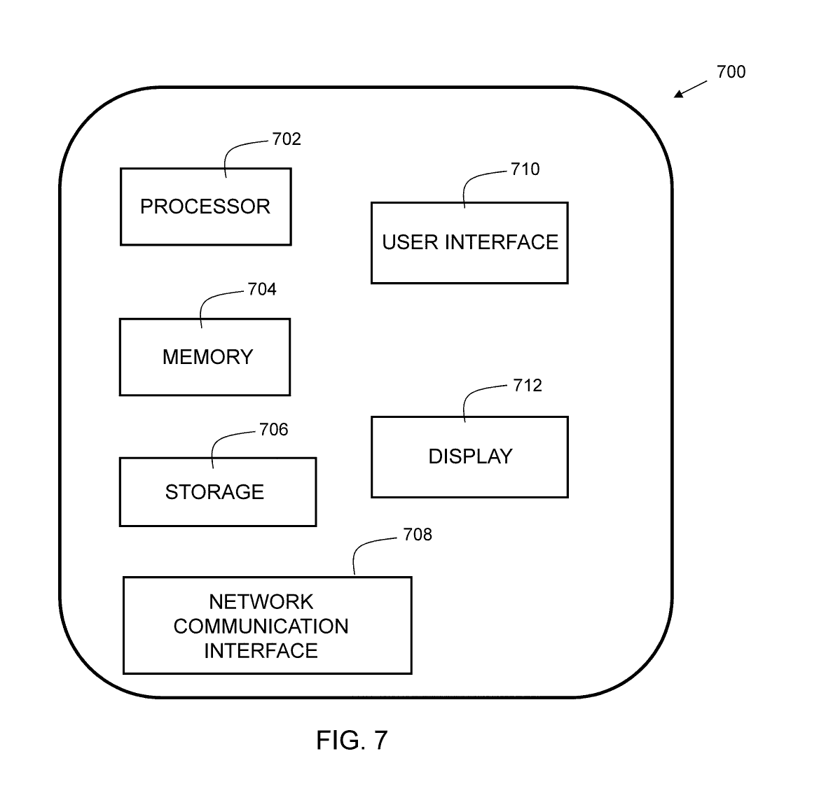

FIG. 7 shows a device 700 in accordance with embodiments of the present invention. Device 700 is an electronic computing device. Device 700 may be representative of a mobile client and/or desktop client shown in FIG. 6. Device 700 includes a processor 702, which is coupled to a memory 704. Memory 704 may include dynamic random access memory (DRAM), static random access memory (SRAM), magnetic storage, and/or a read only memory such as flash, EEPROM, optical storage, or other suitable memory. In some embodiments, the memory 704 is a non-transitory memory. Memory 704 includes instructions, which when executed by the processor, may implement one or more steps of embodiments of the present invention. The memory 704 may include instructions, that when executed by processor 702, send a request to the project management computer 604 to create a project, task, subtask, and/or discrete action. Similarly, the memory 704 may include instructions, that when executed by processor 702, send a request to the project management computer 604 to delete and/or edit a project, task, subtask, and/or discrete action. In embodiments, permissions may be established for each user, such that only certain users (e.g. a project manager) can edit items, whereas other users may access the project, task, subtask, and discrete actions in a read-only mode.

Device 700 may further include storage 706. In embodiments, storage 706 may include one or more magnetic storage devices such as hard disk drives (HDDs). Storage 706 may include one or more solid state drives (SSDs). Any other storage device may be included instead of, or in addition to, those disclosed herein.

Device 700 may further include a display 712, examples of which include a liquid crystal display (LCD), a plasma display, a cathode ray tube (CRT) display, a light emitting diode (LED) display, an organic LED (OLED) display, or other suitable display technology. The display may include a touch screen incorporating a capacitive or resistive touch screen in some embodiments. The device 700 may further include user interface 710 such as a keyboard, mouse, and/or buttons, etc.

The device 700 may further include a network communication interface 708. In some embodiments, the communication interface 708 may include a wireless communication interface that includes modulators, demodulators, and antennas for a variety of wireless protocols including, but not limited to, Wi-Fi, and/or cellular communication protocols for communication over a computer network.

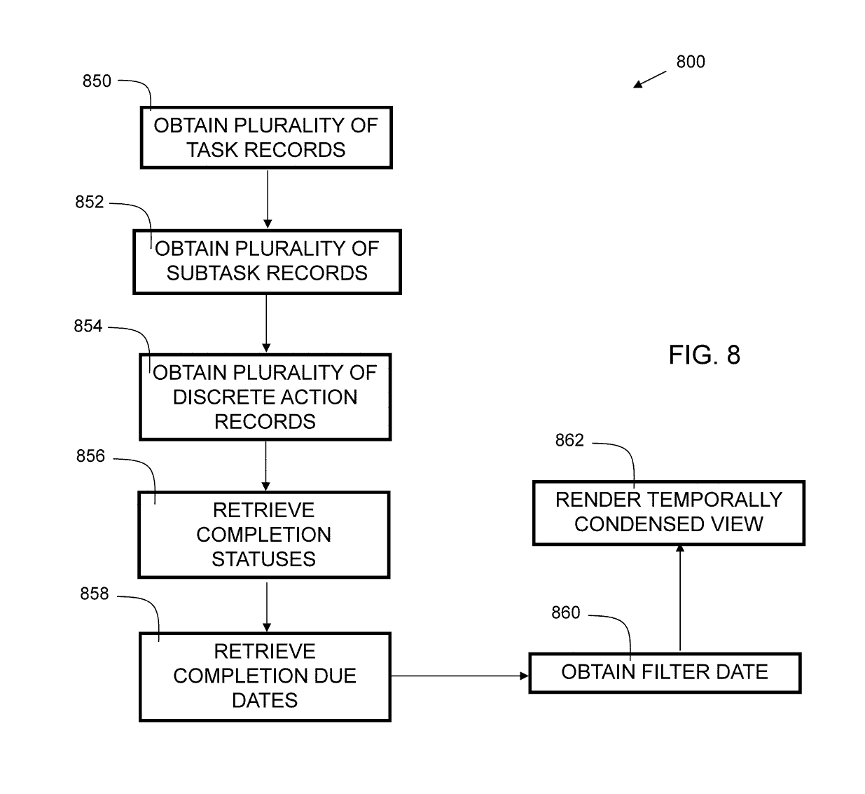

FIG. 8 is a flowchart 800 indicating process steps for embodiments of the present invention. In process step 850, a plurality of task records is obtained by a computer system. In process step 852, a plurality of subtask records is obtained by the computer system. In process step 854, a plurality of discrete action records is obtained by the computer system. In process step 856, completion statuses for each item are retrieved from the records by the computer system. In process step 858, completion due dates are retrieved from the records by the computer system. In process step 860, a filter date is received by the computer system. In process step 862, the computer system renders a temporally condensed view based on the obtained filter date, completion statuses, and completion due dates. Items that are overdue may be rendered with an indication such as a late discrete action indication. Items (e.g. subtasks, discrete actions, etc.) may be rendered using a particular color, font, pattern, or other visually distinctive attribute to indicate ownership of the item to a particular organization and/or individual. Note that while the flowchart 800 shows a particular order, other embodiments may use a different order. Furthermore, in embodiments, one or more of the steps shown may be performed concurrently.

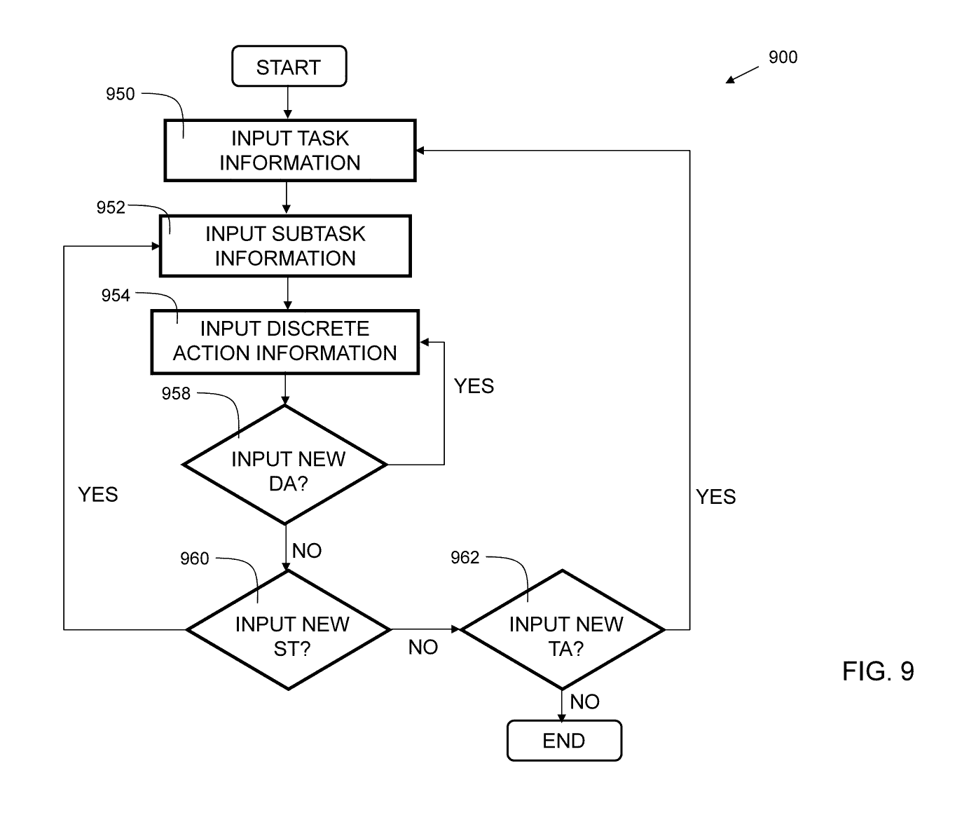

FIG. 9 is a flowchart 900 showing data entry steps. In process step 950, task information is input. In process step 952, subtask information for a given task is input. In process step 954, discrete actions for a given subtask are input. In process step 958, a check is made to determine if any new discrete actions are to be entered. If yes, then the process returns to process step 954. If no, then the process continues to process step 960 where a check is made to determine if any new subtasks (ST) are to be entered. If yes, then the process returns to process step 952. If no, then the process continues to process step 962 where a check is made to determine if any new tasks (TA) are to be entered. If yes, then the process returns to process step 950, otherwise, the process ends.

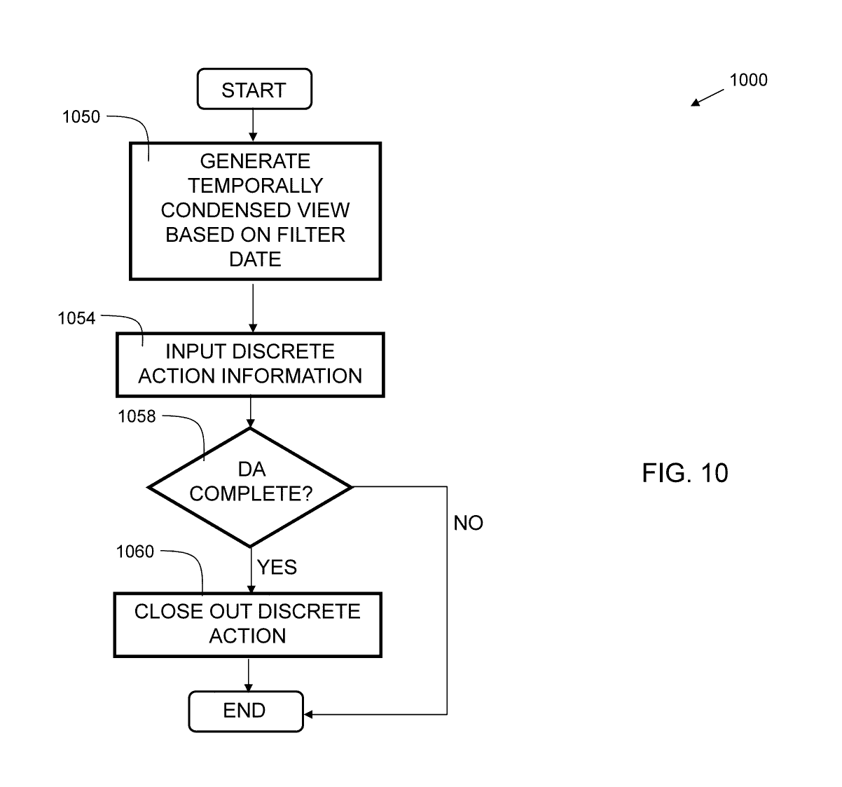

FIG. 10 is a flowchart 1000 showing discrete action management steps. In process step 1050, a temporally condensed view is generated based on a filter date. In process step 1054, discrete action information is input. This can include updating one or more attributes of a discrete action including, but not limited to, completion status, estimated completion date, and/or owner. At process step 1058, a check is made by a computer-implemented method to determine if the discrete action is complete. If yes, then at process step 1060 the discrete action is closed out and may be removed from the current temporally condensed view and the process ends. If no, then the discrete action is not closed out and the process ends.

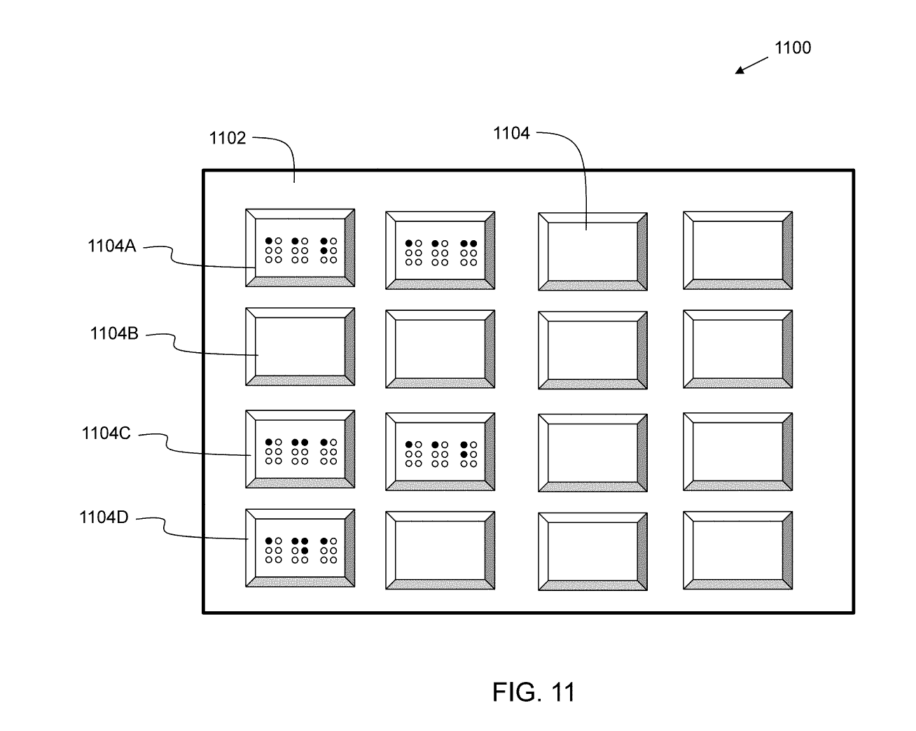

FIG. 11 illustrates an exemplary three-dimensional temporally condensed rendering 1100 of outstanding discrete actions in accordance with embodiments of the present invention. Rendering 1100 may be rendered by a 3D printer such as 3D printer 630 of system 600. The rendering 1100 may be made on a substrate 1102, such as a plastic substrate. A plurality of raised areas 1104 may be formed by the 3D printer, or alternatively may be pre-formed on the substrate 1102. The 3D printer then may form a tactile feature such as Braille characters as indicated in raised area 1104A, 1104C, and 1104D. The Braille characters can represent a discrete action. Raised area 1104B is blank, indicating there is no discrete action at that location. A visually impaired user can feel the rendering 1100 and determine numbers corresponding to discrete actions. The user can then speak the discrete action number into a computer, where the computer is executing speech-to-text software which then can convert the discrete action number to text, retrieve information from the storage containing the project information (e.g. 610 of FIG. 6). Using text-to-speech software, the computer can then produce an audible output for the visually impaired user. In this way, a visually impaired user can take advantage of the temporally condensed rendering to gain an improved understanding of the status of a complex project. Thus, embodiments can include rendering, on a substrate, a three-dimensional temporally condensed view of outstanding discrete actions based on the filter date.

As can now be appreciated, disclosed embodiments enable improved understanding of outstanding items in a complex project. A temporally compressed view allows a user to see outstanding items without chronological gaps. In some embodiments, a tactile temporally compressed rendering allows visually impaired users to interpret the temporally compressed view. Note that while the aforementioned example used weeks as the fundamental time unit, other embodiments may use days, hours, months, years, or other suitable time units.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A computer-implemented method for task scheduling of one or more tasks, subtasks, and discrete actions, comprising:
obtaining a plurality of task records from a database;
obtaining a plurality of subtask records from the database;
obtaining a plurality of discrete action records from the database;
retrieving a completion status for each task record, subtask record, and discrete action record;
retrieving a completion due date for each task record, subtask record, and discrete action record;
obtaining a filter date; and
rendering, on an electronic display, a temporally condensed view of outstanding discrete actions based on the filter date.

2. The method of claim 1, further comprising assigning a color to each discrete action based on a discrete action owner.

3. The method of claim 1, further comprising assigning a unique number to each discrete action based on a unique project number.

4. The method of claim 1, further comprising rendering a late discrete action indication.

5. The method of claim 1, further comprising rendering, on a substrate, a three-dimensional temporally condensed view of outstanding discrete actions based on the filter date.

6. The method of claim 1, wherein obtaining a filter date comprises obtaining a present filter date.

7. The method of claim 1, wherein obtaining a filter date comprises obtaining a future filter date.

8. An electronic device for task scheduling of one or more tasks, subtasks, and discrete actions, comprising:
a processor;
a memory coupled to the processor;
a display coupled to the processor;
wherein the memory contains instructions, which when executed by the processor, perform the steps of:
obtaining a plurality of task records from a database;
obtaining a plurality of subtask records from the database;
obtaining a plurality of discrete action records from the database;
retrieving a completion status for each task, subtask, and discrete action;
retrieving a completion due date for each task, subtask, and discrete action;
obtaining a filter date; and
rendering, on the electronic display, a temporally condensed view of outstanding discrete actions based on the filter date.

9. The device of claim 8, wherein the memory further contains instructions, that when executed by the processor, perform the step of assigning a color to each discrete action based on a discrete action owner.

10. The device of claim 8, wherein the memory further contains instructions, that when executed by the processor, perform the step of assigning a unique number to each discrete action based on a unique project number.

11. The device of claim 8, wherein the memory further contains instructions, that when executed by the processor, perform the step of rendering a late discrete action indication.

12. The device of claim 8, wherein the memory further contains instructions, that when executed by the processor, perform the step of obtaining a past filter date.

13. The device of claim 8, wherein the memory further contains instructions, that when executed by the processor, perform the step of obtaining a present filter date.

14. The device of claim 8, wherein the memory further contains instructions, that when executed by the processor, perform the step of obtaining a future filter date.

15. A computer program product embodied in a non-transitory computer readable medium for task scheduling of one or more tasks, subtasks, and discrete actions, the computer program product comprising instructions which cause one or more processors to perform operations of:
obtaining a plurality of task records from a database;
obtaining a plurality of subtask records from the database;
obtaining a plurality of discrete action records from the database;
retrieving a completion status for each task, subtask, and discrete action;
retrieving a completion due date for each task, subtask, and discrete action;
obtaining a filter date; and
rendering, on an electronic display, a temporally condensed view of outstanding discrete actions based on the filter date.

16. The computer program product of claim 15, further comprising instructions which cause one or more processors to perform operations of assigning a color to each discrete action based on a discrete action owner.

17. The computer program product of claim 15, further comprising instructions which cause one or more processors to perform operations of assigning a unique number to each discrete action based on a unique project number.

18. The computer program product of claim 15, further comprising instructions which cause one or more processors to perform operations of rendering a late discrete action indication.

19. The computer program product of claim 15, further comprising instructions which cause one or more processors to perform operations of obtaining a present filter date.

20. The computer program product of claim 15, further comprising instructions which cause one or more processors to perform operations of obtaining a future filter date.
